(19) United States
(12) Patent Application Publication
(10) Pub. No.: US 2017/0122495 A1
(43) Pub. Date: May 4, 2017

(54) DEVICE FOR TRANSPORTING LIQUEFIED GAS AND A METHOD OF TRANSFERRING LIQUEFIED GAS FROM THE DEVICE

(71) Applicant: CRYODIRECT Limited, Hong Kong (HK)

(72) Inventors: Pierre FIAT, Aix-En-Provence (FR); Frederic LEFOL, Trets (FR)

(73) Assignee: CRYODIRECT Limited, Hong Kong (HK)

(21) Appl. No.: 15/337,743

(22) Filed: Oct. 28, 2016

(30) Foreign Application Priority Data
Oct. 29, 2015 (FR) 15 60383

(51) Int. Cl. F17C 7/02; F17C 13/02

(52) U.S. Cl. CPC F17C 7/02; F17C 13/028

(57) ABSTRACT

A method of transferring a liquefied gas under pressure contained in a container into a tank or a gas transport network. The container is connected to a recirculation circuit that includes a heater and a recirculation pump connected in series with the heater, upstream from the heater, and arranged to discharge liquefied gas taken from the bottom of the container into the heater, the method including connecting the container to the tank or to the network, via a circuit for transferring the liquefied gas in the liquid phase and not having a pump; allowing the liquefied gas to be transferred to the tank or to the network via the transfer circuit under the effect of a higher pressure in the container; and operating the pump to compensate for the reduction in pressure inside the container during transfer.

### TECHNICAL FIELD

The present invention relates to a device for transporting and/or storing a liquefied gas and to a method of transferring, or delivering, the liquefied gas from the device.

The present invention applies in particular to containers for transporting or storing refrigerated gas such as oxygen, nitrogen, argon, or liquefied natural gas, for example, which liquefied gas is stored at a pressure of about 10 bars to 20 bars approximately, or of about 3 bars to 30 bars approximately, for example.

### STATE OF THE ART

Transferring a liquefied gas contained under pressure in a container to a gas storage tank, usually referred to as “unloading”, may be performed by making use of a pressure difference, with this mode of transport usually being referred to as “gravity unloading”, or else it may be transferred by pumping.

Gravity unloading requires the pressure in the container to be higher than the pressure in the “client” tank for filling by an amount that is sufficient to ensure that the liquefied gas travels along a transfer circuit connecting the container to the tank, solely under the effect of the difference between these two pressures.

During transfer, the pressure in the container drops as a result of discharging the liquid phase present in the bottom portion of the container into the transfer circuit, and as a result the flow rate of the gas being transferred also drops.

In order to mitigate (at least in part) these drops in pressure and flow rate, it is known to provide the container with a recirculation circuit that connects the bottom of the container to the top portion of the container, which circuit includes a heat exchanger arranged to heat the liquid phase leaving the container via this circuit, so as to cause this liquid phase to boil, this circuit returning with the gas phase that results from this boiling to the gas space inside the container, thereby increasing the pressure inside the container.

The heat exchanger exchanges heat between the gas flowing through the heat exchanger and a heat source, which may be constituted by ambient air, for example, so that the heat exchanger may be referred to as an atmospheric heater.

The (partial) compensation for the drop in pressure inside the container as provided by the recirculation (or heater) circuit also lessens during transfer as a result of the (progressive) lowering of the level of the liquid phase inside the container.

Consequently, unloading is usually performed by pumping using a pump provided in the transfer circuit that is used for feeding the tank with liquefied gas.

A pump for transferring liquefied gas, i.e. a cryogenic pump, generally comprises a pump body and a bladed wheel mounted to rotate inside the pump body.

As described in patent FR 2 822 927, a fraction of the liquid phase delivered by the pump may flow through a heat exchanger for evaporating this liquid phase fraction in order to compensate for the pressure drop inside the container, and also for condensing a gas phase taken from the gas space in a tank being filled from the container. As described in patent FR 2 439 881, before being started, such a pump must be cooled down by using a “natural” (or “gravity”) flow of the liquefied gas through the pump, which generally requires an unwanted waiting time that, under certain circumstances, may last for one or more hours before it is possible to start the pump.

Furthermore, in spite of using pump-starting methods and devices as described in that patent FR 2 439 881, starting and operating the pump correctly remain major sources of difficulty for an operator with ordinary qualifications.

Specifically, transfer pumps operate correctly only in a narrow range of pressures: below a minimum pressure the sealing members of the pump leak; and above a maximum pressure that is not much higher than the minimum pressure, the sealing members and/or the pump suffer premature wear.

Furthermore, transfer pumps are usually driven by an electric motor and consume a large amount of energy.

### SUMMARY OF THE INVENTION

An object of the invention is to propose a device for transporting and/or storing liquefied gas and a method of transferring, or delivering, liquefied gas from the device, that are improved and/or that remedy, at least in part, the shortcomings or drawbacks of known systems for transporting, storing, and/or delivering liquefied gas.

In an aspect of the invention, there is provided a device for transporting or storing liquefied gas under pressure, the device comprising:
a container for containing the liquefied gas under pressure;
a circuit for transferring the liquefied gas in the liquid phase, which circuit is connected to the bottom portion of the container, and includes a member for connection to a tank or to a gas transport network that is to be fed with gas; and
a circuit for recirculating the liquefied gas, which circuit is connected to the top portion of the container and includes a heater and a recirculation pump that is connected in series with the heater, upstream from the heater, and that is arranged to deliver into the heater the pumped liquefied gas taken from the bottom portion of the container so as to accelerate the circulation of the liquefied gas through the heater, thereby increasing heat exchange in the heater and maintaining, or increasing, the pressure of the gas space in the container.

In another aspect of the invention, there is provided a method of transferring liquefied gas under pressure contained in a container into a tank or a gas transport network, wherein the container is connected to a recirculation circuit that includes a heater and a recirculation/heater pump that is connected in series with the heater, upstream from the heater, and that is arranged to discharge liquefied gas taken from the bottom portion of the container into the heater, the method comprising:
connecting the container to the tank or to the network that is to be fed, via a circuit for transferring the liquefied gas in the liquid phase and not having a pump;
allowing the liquefied gas to be transferred to the tank or to the network via the transfer circuit under the effect of the higher pressure in the container (in comparison with the pressure that exists in the tank or the network), or ensuring that it is so transferred; and
operating the recirculation pump to compensate, at least in part, for the reduction in pressure inside the container during transfer.

By way of example, the recirculation pump may be designed to recirculate liquefied gas at a rate lying in a range about 10 liters per hour (L/h) to about one thousand (1000) L/h, or a range about 20 L/h to about 2000 L/h, and to provide a pressure rise (pressure head) lying in a range about one-tenth of a bar (0.1 bar) to about one bar.

In order to maintain sufficient pressure inside the container while transferring the liquefied gas, in particular in order to maintain a pressure inside the container that is substantially constant throughout the transfer, it is possible to measure the pressure that exists inside the container and to control the operation of the pump as a function of the measured pressure.

For this purpose, the transport or storage device may include a pressure-measurement sensor arranged to measure the pressure that exists inside the container, and a control unit connected to the pump and to the pressure-measurement sensor and arranged/configured, in particular programmed, to control the operation of the pump as a function of the pressure measured by the sensor.

The invention applies in particular to storage containers that are thermally insulated and that are supported by a transport structure forming part of the gas transport and storage device, in particular by means of a road transport trailer or by a structure for transport by road, by rail, or by boat, where such a structure generally includes frames in the ISO standard format.

The container may be elongate in shape along a horizontal axis.

The recirculation circuit may include a check valve arranged downstream from the heat exchanger and serving to prevent the gas phase escaping from the container into the circuit when the pump is stopped.

In accordance with another aspect of the invention, in order to cause the liquid phase to circulate in the recirculation circuit, it is possible to make use of an axial flow pump in which a bladed wheel has permanent magnets arranged at the periphery of the wheel, the pump further including a field winding arranged to drive the wheel in rotation by means of the magnets.

The gas transport or storage device may include electrical energy storage means such as a battery for powering the pump, and in particular the field winding of the pump.

Under such circumstances in particular, the gas transport or storage device may also include energy capture means, such as photovoltaic cells, serving to power the energy storage means and/or the pump.

The electrical energy capture and storage means may be secured to, and supported by, the transport structure and/or the container.

The field winding of the pump may be powered by an electrical power supply and control unit that is connected to the field winding.

This unit and the field winding may be arranged to drive the pump wheel at a speed of rotation lying in the range about 1000 revolutions per minute (rpm) to about 5000 rpm, and in particular in a range about 1500 rpm or 2000 rpm to about 4000 rpm or 4500 rpm.

Driving the wheel by the magnetic effect serves in particular to limit, or to avoid, any rise in the temperature of the wheel while the pump is stopped, and consequently facilitates subsequent starting.

The field winding is preferably arranged outside the pump body. In particular, the field winding, and/or the coil of the field winding, may extend facing the magnets and the periphery of the wheel.

The coil of the field winding may be embedded in an electrically insulating material such as a polymer material, such that the coil and the field winding can withstand ice forming on the pump.

The insulating material may be a thermally insulating material, such that the pump body is heated little by the field winding.

The invention also makes it possible to provide and use a pump that is compact and that provides good performance in circulating liquefied gas, that requires little or no cooling prior to operation, and that is easier for a relatively unqualified operator to control.

At least a portion of the bladed wheel, in particular a peripheral structure or portion connecting together the tips of the blades, specifically a peripheral structure of substantially annular shape, may be made out of a magnetic material, in particular out of (ferro)magnetic stainless steel (martensitic or ferritic steel, in particular), in order to facilitate driving the wheel by means of a magnetic field produced by the field winding.

Also for this purpose, the magnets may be secured to such a peripheral portion of the wheel and they may be arranged so as to be substantially flush with the peripheral envelope or envelope surface of the wheel.

The magnets may in particular present the shape of a portion of a cylindrical cap, with a radius of curvature that matches, in particular is substantially equal to, the outside radius of the wheel, so as to minimize the airgap between the magnets and the field winding.

The magnets may be secured to the wheel by friction and/or abutment, in particular by mechanical blocking or by crimping, so as to avoid using an adhesive that might react with the liquefied gas passing through the pump.

The bladed wheel may be mounted to rotate freely on a stationary shaft, or pivot, that is rigidly connected to the pump body by a connection structure that is provided with or pierced by openings allowing the liquefied gas to pass through the structure.

The connection structure may include, or may be essentially constituted by a grid of stationary vanes that may be arranged downstream from the wheel and that may serve to guide the fluid flow so as to improve the efficiency of the pump.

This connection structure may present thermal conductivity that is less than the thermal conductivity of the pump body so as to limit the extent to which the wheel is heated by conduction during periods when the pump is stopped, thereby reducing any need for the pump to be cooled down before starting.

For this purpose, at least a portion of the connection structure may be non-metallic, and in particular it may be made of a synthetic or plastics material such as polytetrafluoroethylene (PTFE).

The connection structure may in particular present thermal conductivity that is less than the thermal conductivity of the wheel, and/or than the thermal conductivity of the shaft.

The pump, and in particular the connection structure, may include a static sealing member suitable for providing the pump body with sealing.

The sealing member may include, or may be essentially constituted by, a thin structure of annular shape such as a thin ring forming a flat gasket, which structure is arranged to provide sealing between two portions of the pump body, each of which has a respective flange, sealing being provided when the two flanges are placed facing each other with the thin sealing structure clamped between them.

The connection between the wheel and the stationary shaft may take place via a single bearing, e.g. a needle bearing or a composite metal/polymer bearing such as a bearing of PTFE coated bronze, thereby contributing to making the pump compact.

The pump body may include a central tubular structure defining a chamber in which the wheel is received. At least a portion of the tubular structure, which extends between the field winding and the periphery of the wheel, may be made out of a non-magnetic material, in particular out of non-magnetic stainless steel.

The chamber may be in the form of a cylinder of diameter that matches the diameter of the wheel (i.e. is a little greater than the diameter of the wheel).

The pump body may also include two flared portions, e.g. of substantially frustoconical shape, that are arranged at opposite ends of the central tubular structure and in line with the tubular structure, i.e. substantially on the same axis, such that the assembly defines a fluid flow passage presenting few edges or discontinuities and/or presenting a flow section that varies substantially continuously, thus tending to prevent bubbles of gas forming in the pump body.

Other aspects, characteristics, and advantages of the invention appear from the following description, which refers to the accompanying figures and shows preferred embodiments of the invention without any limiting character.

### BRIEF DESCRIPTION OF THE FIGURES

FIG. 1 is a diagram of a device for transporting and storing liquefied gas.

FIG. 2 is an exploded diagrammatic perspective view showing a pump for transferring/circulating liquid gas.

FIG. 3 is an exploded diagrammatic perspective view in perspective from another viewpoint showing the pump of FIG. 2.

FIG. 4 is a diagrammatic longitudinal section view on a larger scale showing the central portion of a pump similar to that of FIGS. 2 and 3.

### DETAILED DESCRIPTION OF THE INVENTION

Unless stated explicitly or implicitly to the contrary, elements or members that are structurally or functionally identical or similar are identified in the various figures by identical references.

Unless stated explicitly or implicitly to the contrary, the terms “upstream” and “downstream” are used relative to the flow direction of the liquefied gas.

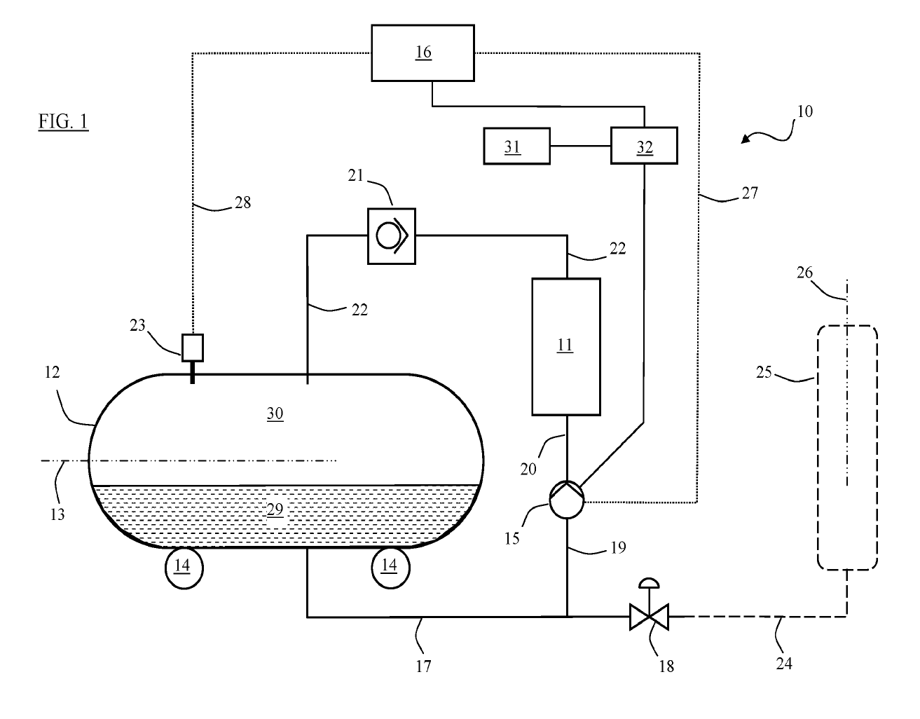

With reference to FIG. 1, the device 10 serves for transporting, and where applicable for storing, a liquefied gas 29, 30 under pressure.

For this purpose, the device 10 has a container 12 of elongate shape with an axis 13 that is substantially horizontal, which container is thermally insulated.

In order to transport gas, the container 12 is movable so as to be suitable for taking to the proximity of a tank 25 that is to be filled with liquefied gas.

In the embodiment shown in FIG. 1, the tank 25 is of elongate shape with an axis 26 that is substantially vertical, and it is connected to the device 10 by a connection member 24 that is essentially constituted by a liquefied gas transport duct 24, which may be a flexible hose.

For (temporary) storage of gas, the container 12, which may be stationary, may be connected to a gas transport network 24 that is to be supplied with gas.

In the container 12, the gas phase 30 overlies the liquid phase 29 of the liquefied gas that can be maintained in the container at a temperature situated in a range from about minus two hundred degrees Celsius (−200° C.) to about −50° C., for example.

The container 12 is mounted on a road transport trailer suitable for moving the container 12, the trailer being represented diagrammatically in FIG. 1 by wheels 14.

Alternatively, the container 12 may be secured to a structure (not shown) for transport by boat, which structure may be incorporated in the volume of an ISO container, for example.

In order to feed the tank 25 or a gas transport network with liquefied gas, the device 10 has a transfer circuit for transferring liquefied gas in the liquid phase.

This circuit comprises a duct 17 that is connected to the bottom to the container 12 and opens out in the container at a first end of the duct 17.

The transfer circuit also has an isolation valve 18 located at a second end of the duct 17 and enabling the duct to be closed.

The duct 24 for connecting the device 10 to the tank 25 extends the duct 17 beyond the valve 18.

The device 10 also has a liquefied gas recirculation circuit that is connected to the top portion of the container and that opens out into the container via an end of a duct 22 forming part of this circuit.

The recirculation circuit comprises the following items successively connected together in pairs (i.e. in series):

i) a duct 19 connected to the duct 17; alternatively, the duct 19 may be connected to the bottom portion of the container 12 by opening out into the container;

ii) a recirculation pump 15 connected to the duct 19 via its suction orifice and designed to suck in liquefied gas in the liquid phase transported by this duct;

iii) a duct 20 connected to the delivery orifice of the pump 15;

iv) a heater 11 connected to the duct 20 to receive the liquefied gas delivered by the pump and transported by the duct 20 in order to evaporate the gas by exchanging heat with a heat source such as ambient air; and

v) a duct 22 for transporting the gas exhausted from the heater 11, generally in gaseous form, and taking it to the container 12, which duct may be fitted with a check valve 21 preventing the gas phase 30 contained in the container 12 from being exhausted towards the heater 11.

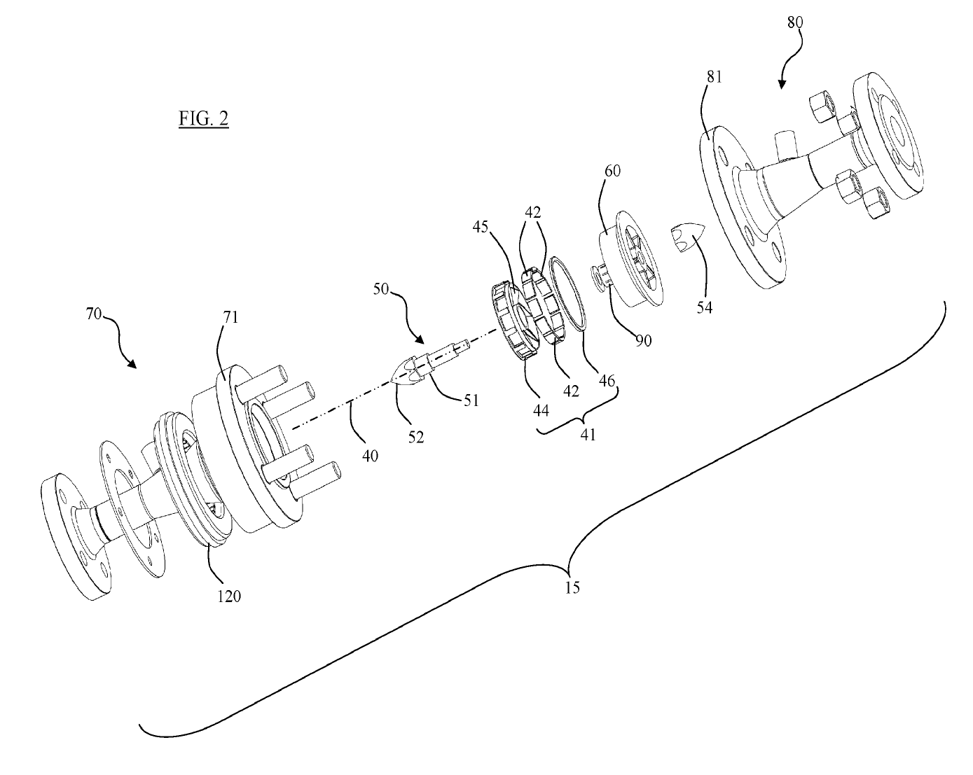

As described in detail below with reference to FIGS. 2 to 4, the axial flow pump 15 comprises a pump body, a bladed wheel mounted to rotate inside the pump body, and an electric motor for driving the wheel in rotation.

The motor comprises a permanent magnet armature secured to the wheel and a field winding arranged outside the pump body.

The bladed wheel is of the “helical” or “axial” type serving to move the pumped liquefied gas substantially along the axis of rotation of the wheel, which axis coincides substantially with an axial axis of symmetry of the pump body.

The bladed wheel has a row of blades 45 arranged in annular cascade.

The motor of the pump may be powered electrically by an electricity distribution network to which the motor and the pump 15 is connected.

Alternatively, or in addition, the motor may be powered electrically by a battery 32 for storing electrical energy that may be secured to the transport structure and/or to the container 12, and that is connected to the motor of the pump 15.

In this configuration in particular, the device 10 may include photovoltaic solar cells 31 serving to feed electricity to the storage battery 32 and/or to the pump 15, and that may be secured to the transport structure and/or to the container 12.

In order to enable the operation of the pump to be controlled so as to ensure a determined pressure inside the container 12 while the tank 25 is being filled, the device 10 may include a pressure-measurement sensor 23 arranged to measure the pressure that exists in the gas phase inside the container 12, and a control unit 16 connected to the pump 15 and to the sensor 23 and arranged, in particular programmed, to control the operation of the pump 15 as a function of the pressure measured inside the container 12.

In this respect, when the recirculation pump is stopped (deenergized), and assuming the valves of the recirculation circuit are open, recirculation of gas may take place in the recirculation circuit, at a low flow rate, due to gas boiling in the heater 11. Energizing the pump to rotate the bladed wheel in a first direction of rotation will result in a higher recirculation flow rate, and energizing the pump to rotate in a second (opposite) direction of rotation will result in a lower or zero recirculation flow rate. To this end, the device may include control means for driving the pump, the control means including means for rotating the bladed wheel in a first direction of rotation and means for rotating the bladed wheel in a second—opposite—direction of rotation.

With reference to FIGS. 2 to 4, the cryogenic pump 15 comprises a pump body 70, 80, 100 and a wheel 41 having blades 45 that is mounted to rotate inside the pump body, about an axis of rotation 40, which is a general axis of symmetry of the pump and most of the parts making it up.

The pump body has a central tubular structure 100 defining a cylindrical chamber 110 that receives the wheel 41, the chamber 110 being cylindrical in shape about the axis 40 and of inside diameter that is slightly greater than the outside diameter of the wheel.

The wheel 41 has magnets 42 arranged at the periphery of the wheel and regularly spaced apart.

The wheel 41 has an annular peripheral ring 44 connected to the tip of the blades 45 that are surrounded by the ring.

The magnets 42 are secured to the peripheral ring 44 of the wheel and they are arranged to be substantially flush with the peripheral envelope of the wheel.

Each magnet 42 is in the form of a portion of a cylindrical cap with a radius of curvature that matches the outside radius of the ring 44 and/or of the wheel 41.

On its outside face, the ring 44 has notches 43 of identical shape and dimensions matching the magnets, which are regularly spaced apart around the outline of the wheel.

The magnets 42 are inserted in the notches 43 and they are held in place by means of a second ring 46 of diameter matching that of the first ring 44 so that the ring 46 can be secured to the first ring 44, e.g. by crimping, so as to ensure that the magnets are mechanically fastened to the periphery of the wheel.

At least a portion of the wheel 41, and in particular the rings 44 and 46, is/are preferably made of a magnetic material such as a ferromagnetic stainless steel.

The wheel 41 is mounted to rotate freely about the axis 40 inside the chamber 110 on a stationary shaft 50.

The shaft 50 has a cylindrical bearing surface 51 of axis 40 having a rolling bearing 90 engaged thereon, e.g. a needle bearing, which constitutes a bearing for the wheel 41, allowing the wheel to rotate freely on the shaft 50.

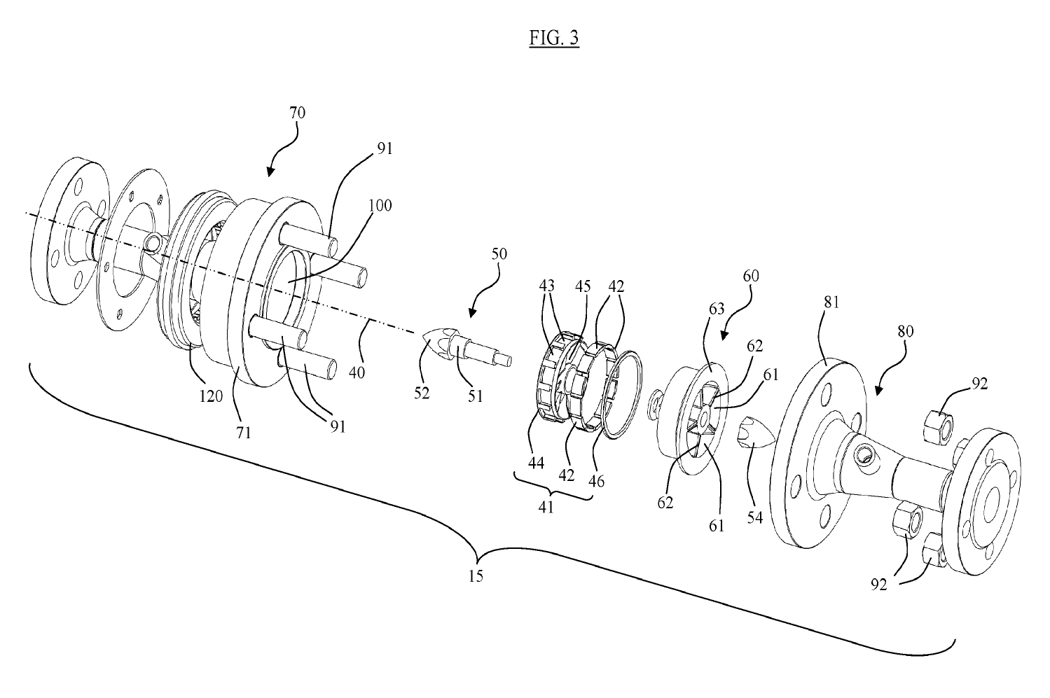

Each end 52, 54 of the shaft 50, which extends from upstream to downstream relative to the wheel 41, i.e. from left to right relative to the wheel in FIGS. 2 and 3, presents a streamlined shape for guiding the liquefied gas both before and after its passage through the wheel.

The shaft 50 is rigidly connected to the pump body by a connection structure 60 pierced by openings 61 that enable the liquefied gas to pass through the structure.

The connection structure 60 is fastened to the second end 53 of the shaft 50 and extends downstream from the wheel 41.

The structure 60 comprises a grid of stationary vanes 62 defining the openings 61, possibly serving to guide the flow, and connecting a central portion of the structure 60 to an annular peripheral portion of the structure 60.

The pump also has a field winding 120 serving to produce a magnetic field for driving the wheel in rotation by means of the magnets.

The tubular structure 100, which extends between the field winding and the periphery of the wheel, is made of a non-magnetic material.

The field winding 120 is arranged outside the pump body, facing and around the tubular structure 100, and facing and close to the magnets situated at the periphery of the wheel.

The coil of the field winding is embedded in an insulating material 121, thus keeping the coil separate from the tubular wall 100 forming a portion of the pump body.

The pump body also has two tubular segments 70 and 80 having two respective flared portions 72 and 82 that are arranged on either side of and in line with the central tubular structure 100.

The connection structure 60 has a collar 63 lying in a plane perpendicular to the axis 40 and projecting outwards from the chamber 110 that receives the shaft 50, the wheel 41, and a substantial fraction of the structure 60.

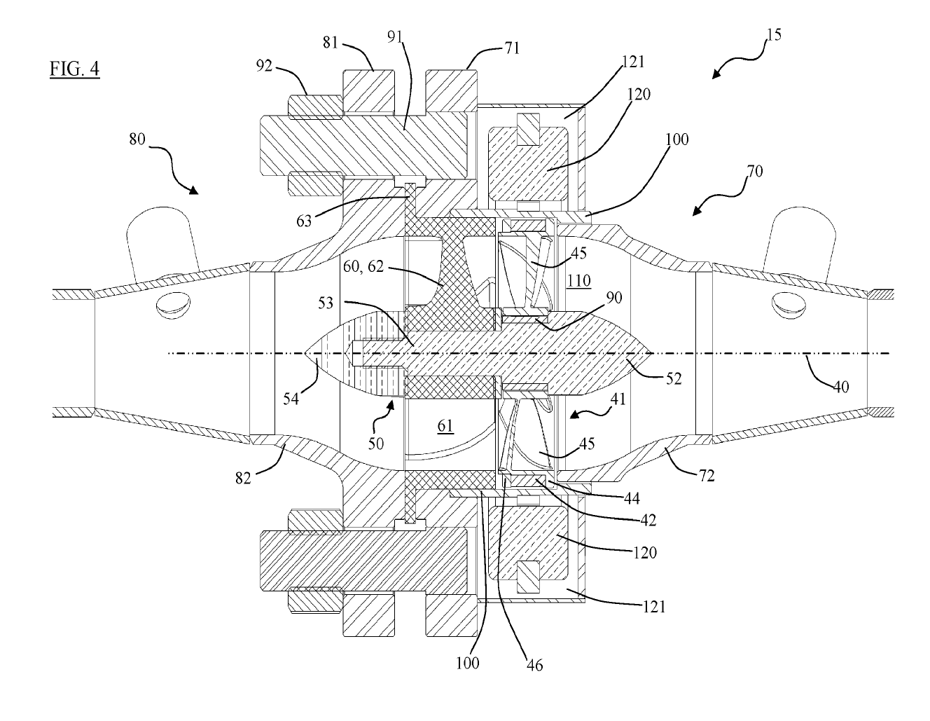

The collar 63 forms a static sealing member for providing sealing between the two portions 70, 80, and 100 of the pump body, which are themselves provided with respective flanges 71 and 81, sealing being provided when these two flanges are arranged facing each other and are assembled together by bolts 91, 92, clamping the collar 63 between them, as shown in FIG. 4.

1. A method of transferring a liquefied gas, that is contained in a container under pressure into a tank or a gas transport network, the container being thermally insulated, the container is connected to a recirculation circuit that includes a heater and a recirculation pump that is connected in series with the heater, upstream from the heater, and that is arranged to discharge liquefied gas taken from the bottom portion of the container into the heater, the method comprising:
connecting the container to the tank or to the network that is to be fed, via a transfer circuit for transferring the liquefied gas in the liquid phase and not having a pump;
allowing the liquefied gas to be transferred to the tank or to the network via the transfer circuit under the effect of a higher pressure in the container, or ensuring that it is so transferred; and
operating the pump to compensate, at least in part, for the reduction in pressure inside the container during the liquefied gas transfer.

2. The method according to claim 1, wherein, in order to maintain sufficient pressure inside the container while transferring liquefied gas, the pressure that exists inside the container is measured and the operation of the pump is controlled as a function of the measured pressure.

3. The method according to claim 1, wherein the liquefied gas is oxygen, nitrogen, argon, or liquefied natural gas.

4. The method according to claim 1, wherein the liquefied gas is maintained at a temperature situated in a range from about minus two hundred degrees Celsius (200° C.) to about minus fifty degrees Celsius (50° C.)

5. The method according to claim 1, wherein the pump ensures that the pressure of the liquefied gas is raised by an amount lying in the range about 0.1 bar to about 1 bar.

6. The method according to claim 1, further comprising using a device for transporting or storing a liquefied gas.

7. A device for transporting or storing a liquefied gas, the device comprising:
a container for containing the liquefied gas under pressure, the container being thermally insulated;
a transfer circuit for transferring the liquefied gas in the liquid phase, which circuit is connected to the bottom portion of the container, does not include a pump, and includes a member for connection to a tank or to a gas transport network that is to be fed with gas; and
a recirculation circuit for recirculating the liquefied gas, which circuit is connected to the top portion of the container and includes a heater and a recirculation pump that is connected in series with the heater, upstream from the heater, and that is arranged to deliver into the heater the liquefied gas taken from the bottom portion of the container so as to accelerate the circulation of the liquefied gas through the heater, thereby increasing heat exchange in the heater and maintaining, or increasing, the pressure of the gas space in the container.

8. The device according to claim 7, wherein the container is supported by a transport structure for transport by road, by rail, or by boat.

9. The device according to claim 8, wherein the transport structure is a road transport trailer.

10. The device according to claim 7, wherein the container is of elongate shape along a horizontal axis.

11. The device according to claim 7, wherein the recirculation circuit includes a check valve arranged downstream from the heater.

12. The device according to claim 7, wherein the pump includes a wheel having a row of blades with permanent magnets arranged at the periphery of the wheel, and a field winding arranged to drive the wheel in rotation by means of the magnets.

13. The device according to claim 7, wherein the pump is an axial flow pump including a bladed wheel serving to move the pumped liquefied gas substantially along an axis of rotation of the wheel.

14. The device according to claim 7, including electrical energy storage means for powering the pump, which energy storage means are secured to the container or to a transport structure for the container.

15. The device according to claim 14 including energy capture means for powering the storage means and/or the pump, which energy capture means are secured to the container or to a transport structure for the container.

16. The device according to claim 7 including a pressure-measurement sensor arranged to measure the pressure that exists inside the container, and a control unit connected to the pump and to the sensor and arranged to control the operation of the pump as a function of the measured pressure.

17. A device for transporting or storing a liquefied gas, the device comprising:
a container for containing the liquefied gas under pressure, the container being thermally insulated;
a transfer circuit for transferring the liquefied gas in the liquid phase, which circuit is connected to the bottom portion of the container, does not include a pump, and includes a member for connection to a tank or to a gas transport network that is to be fed with gas; and
a recirculation circuit for recirculating the liquefied gas, which circuit is connected to the top portion of the container and includes a heater and a recirculation pump that is connected in series with the heater, upstream from the heater, and that is arranged to deliver into the heater the pumped liquefied gas taken from the bottom portion of the container so as to accelerate the circulation of the liquefied gas through the heater, thereby increasing heat exchange in the heater and maintaining, or increasing, the pressure of the gas space in the container;
wherein the pump is an axial flow pump including a bladed wheel serving to move the liquefied gas substantially along an axis of rotation of the wheel, and wherein the pump includes a wheel having a row of blades with permanent magnets arranged at the periphery of the wheel, and a field winding arranged to drive the wheel in rotation by means of the magnets.

18. The device according to claim 17, wherein the container is supported by a transport structure for transport by road, by rail, or by boat.

19. The device according to claim 18, wherein the transport structure is a road transport trailer.

20. The device according to claim 17, wherein the container is of elongate shape along a horizontal axis.

21. The device according to claim 17, wherein the recirculation circuit includes a check valve arranged downstream from the heater.

22. The device according to claim 17, including electrical energy storage means for powering the pump, which energy storage means are secured to the container or to a transport structure for the container.

23. The device according to claim 22 including energy capture means for powering the storage means and/or the pump, which energy capture means are secured to the container or to a transport structure for the container.

24. The device according to claim 17 including a pressure-measurement sensor arranged to measure the pressure that exists inside the container, and a control unit connected to the pump and to the sensor and arranged to control the operation of the pump as a function of the measured pressure.
